(19) United States
(12) Patent Application Publication
(10) Pub. No.: US 2014/0091052 A1
(43) Pub. Date: Apr. 3, 2014

(54) IODINE-BASED ETCHING SOLUTION AND ETCHING METHOD

(71) Applicant: Kanto Kagaku Kabushiki Kaisha, Tokyo (JP)

(72) Inventors: Kazuaki Nagashima, Soka-shi (JP); Hideki Takahashi, Soka-shi (JP)

(73) Assignee: Kanto Kagaku Kabushiki Kaisha, Tokyo (JP)

(21) Appl. No.: 14/039,221

(22) Filed: Sep. 27, 2013

(30) Foreign Application Priority Data
Sep. 28, 2012 (JP) 2012-217438

(51) Int. Cl. C09K 13/00; C23F 1/44; C23F 1/42

(52) U.S. Cl. CPC C09K 13/00; C23F 1/42; C23F 1/44
USPC 216/13; 252/79.1

(57) ABSTRACT

Technical Problem

The present invention aims to provide an iodine-based etching solution having a high ratio of etching rate of a palladium material to that of a metal material other than the palladium material, in particular, an iodine-based etching solution capable of relatively decreasing the concentration of an organic solvent in the etching solution.

Solution to Problem

The iodine-based etching solution of the present invention is an iodine-based etching solution to etch a material in which a palladium material and a metal material other than the palladium material coexist, and comprises a water-compatible organic solvent and a water-soluble polymer compound.

### TECHNICAL FIELD

The present invention relates to an iodine-based etching solution and an etching method.

### BACKGROUND ART

Metals such as gold, palladium, etc. are widely used as electrode wiring materials, etc. of semiconductors and liquid crystal displays in general. As microfabrication technology of such metal electrode wiring, there is a wet etching method using chemicals. In particular, in recent years flip chip method has become the mainstream in bonding of electrode wiring, and etching solutions are frequently used in a step of forming bumps.

Conventionally, as such etching solutions, an iodine-based etching solution containing an organic solvent is known (Patent Document 1, for example). However, while said etching solution showed a small change in the etching performance and was capable of stable etching of gold, when it was used to etch a palladium base simultaneously with gold bumps in the step of forming gold bumps, it was impossible to control the amount of etching of each metal.

Furthermore, an etching method of gold, palladium and alloys thereof using an etching solution wherein iodine is a major reactant has been known (Patent Document 2). However, this method was unable to similarly etch gold and palladium and to selectively remove base palladium while suppressing damage to bumps, i.e., suppressing etching of gold.

Under such circumstances, the inventors have found an etching solution having high selectivity for palladium, which is used for etching materials wherein palladium and gold coexist, as well as a method to control the selectivity for palladium etching (Patent Document 3).

### CITATION LIST

### Patent Documents

Patent Document 1: JP A 2004-211142
Patent Document 2: JP A 49-123132
Patent Document 3: WO 2007/049750

### SUMMARY OF THE INVENTION

### Technical Problem

However, in the method described in Patent Document 3, in order to increase the ratio of etching rate of palladium to that of gold, for example, in order to make the ratio 1.5 or more, the etching solution must comprise high concentration of an organic solvent, for example, 80 vol % or more of an organic solvent. Such an etching solution attacks the resists at high degrees, so that its operating condition is limited; in addition, some organic solvents are designated as hazardous materials under the Fire Defense Law, and therefore complicated control is required.

Thus, for the material comprising a palladium material and other metal material, it has conventionally been difficult to make the concentration of an organic solvent in the etching solution fairly low, while increasing the ratio of etching rate of the palladium material to that of the metal material. Accordingly, it has been difficult to adjust the etching rate ratio within a certain range including a fairly high range.

Thus, the present invention aims to provide an iodine-based etching solution having a high etching rate ratio of the palladium material relative to the metal material, in particular, an iodine-based etching solution capable of decreasing the concentration of an organic solvent in the etching solution to a fairly low level, and an etching method capable of adjusting the etching rate ratio within a fairly large range.

### Solution to Problem

During investigation to solve the above problems, the present inventors have found that when a composition comprising a specific organic solvent and a water-soluble polymer compound is used as an etching solution, the ratio of etching rate of palladium material to that of other metal material is fairly increased; and after further research, the inventors have accomplished the present invention.

Namely, the present invention relates to the following.

[1] An iodine-based etching solution to etch a material in which a palladium material and a metal material other than the palladium material coexist, comprising a water-compatible organic solvent and a water-soluble polymer compound.
[2] The iodine-based etching solution according to [1], wherein the water-soluble polymer compound decreases the etching rate of the metal material by adhering to the surface of the metal material.
[3] The iodine-based etching solution according to [1] or [2], wherein the water-soluble polymer compound is one or more kinds selected from the group consisting of polyvinyl alcohol, polyvinyl pyrrolidinone, and polyethylene imine.
[4] The iodine-based etching solution according to [1] or [2], wherein the water-soluble polymer compound is a nonionic polymer compound.
[5] The iodine-based etching solution according to any one of [1] to [4], wherein the weight-average molecular weight of the water-soluble polymer compound is 300 or more.
[6] The iodine-based etching solution according to any one of [1] to [5], wherein the content of the water-soluble polymer compound is 1-1000 ppm.
[7] The iodine-based etching solution according to any one of [1] to [6], wherein the organic solvent comprises one or more kinds selected from the group consisting of a nitrogen-containing five-membered ring compound, an alcohol compound, an amide compound, a ketone compound, an organic sulfur compound, an amine compound, and an imide compound.
[8] The iodine-based etching solution according to any one of [1] to [7], wherein the concentration of the organic solvent is 1-60 vol %.
[9] The iodine-based etching solution according to any one of [1] to [8], further comprising a thiocyanate compound.
[10] The iodine-based etching solution according to any one of [1] to [9], wherein the metal material is one or more kinds selected from the group consisting of gold, cobalt, nickel, aluminum, molybdenum, tungsten, and an alloy thereof.
[11] The iodine-based etching solution according to any one of [1] to [10], wherein the metal material is gold or gold alloy.
[12] A method of etching a material in which a palladium material and a metal material other than the palladium material coexist using an iodine-based etching solution,
wherein the iodine-based etching solution comprises a water-compatible organic solvent and a water-soluble polymer compound,
wherein the method comprises a step of adjusting the ratio of etching rate of the palladium material to that of the metal material by adjusting the content(s) of the organic solvent and/or the water-soluble polymer compound in the iodine-based etching solution.

### Advantageous Effects of Invention

According to the present invention, it is possible to provide an iodine-based etching solution having a high etching rate ratio of a palladium material relative to a metal material other than the palladium material, in particular, an iodine-based etching solution capable of decreasing the concentration of an organic solvent in the etching solution to a fairly low level, and an etching method capable of adjusting the etching rate ratio within a fairly large range.

The reason why such a high etching rate ratio of palladium material relative to other metal material is obtained has not been clarified; however, by comprising a water-compatible organic solvent and a water-soluble polymer in the etching solution, occurrence of the following action can be considered.

Namely, because the etching solution comprises a water-compatible organic solvent, while a decrease in the etching rate of palladium material is suppressed, the etching rate of other metal material largely decreases. As a result, the ratio of etching rate of palladium material to that of other metal material increases.

In detail, the rate of dissolution of an etched material is largely affected by the supply rate of iodine ions involved in the dissolution from the iodine-based etching solution to the surface of the etched material, and by the moving speed of iodides produced by the dissolution toward the iodine-based etching solution; the larger the supply rate and the moving speed, the larger the rate of dissolution of the etched material. Here, the above supply rate and moving speed are driven by diffusion resulting from differences in the concentration of reactive species (iodine ions, iodides) between the surface of the etched material (reaction field) and the iodine-based etching solution. In a system comprising an organic solvent (a mixed system of water/organic solvent), as a result of suppression of dissociation of ions, the entire activity decreases, and the difference in the concentration of reactive species between the surface of the etched material and the etching solution decreases, which probably results in a decrease in diffusion rate. However, regarding the palladium material, an organic solvent acts as a ligand to produce a palladium coordination compound, thereby suppressing the decrease in the etching rate. On the other hand, regarding other metal materials such as gold, etc., an organic solvent hardly acts as a ligand, and therefore its etching rate significantly decreases.

Next, when the iodine-based etching solution comprising such a water-compatible organic solvent further comprises a water-soluble polymer compound, compared to that without a water-soluble polymer compound, while the etching rate of palladium material is maintained at a similar level, the etching rate of other metal materials decreases. As a result, compared to the etching solution without water-soluble polymer compound, the etching rate ratio of palladium material relative to metal material increases.

This is considered to be because of the following: as a result of adherence of the water-soluble polymer compound to the surface of the metal material, the above dissolution reaction on the surface of said metal material is suppressed; whereas the water-soluble polymer compound hardly adheres to the surface of the palladium material, and therefore the above dissolution reaction on the surface of the palladium material is not suppressed by said water-soluble polymer compound.

As described above, when the iodine-based etching solution of the present invention is used, the etching rate ratio of palladium material relative to metal material can be increased, for example increased by 1.5 fold or more. In addition, since the etching rate ratio can be maintained at a high value even when the content of the water-compatible organic solvent is fairly decreased, it is possible to decrease the content of the water-compatible organic solvent, taking into account its attacking characteristic to resists.

Moreover, by adjusting the contents of a water-compatible organic solvent and a water-soluble polymer material in the iodine-based etching solution, the etching rate ratio of palladium material relative to other metal material can be adjusted. Namely, depending on the object of production, the etching rate ratio of palladium material to other metal material can be arbitrarily set within a fairly large range.

Furthermore, particularly when the iodine-based etching solution comprises a thiocyanate compound, formation of palladium coordination compounds can be promoted compared to formation of coordination compounds of other metal materials; accordingly, the etching rate ratio of the palladium material relative to other metal materials can be further increased.

### BRIEF DESCRIPTION OF THE DRAWINGS

FIG. 1 is a graph showing the relationship between the amount of addition of polyvinyl pyrrolidinone (PVP) and the etching rate, when the material wherein palladium and gold coexist is etched.

FIG. 2 is a graph showing the relationship between the amount of addition of potassium thiocyanate (KSCN) and the etching rate, when the material in which palladium and gold coexist is etched.

### DESCRIPTION OF EMBODIMENTS

Hereinafter, the present invention is described in detail based on preferred embodiments.

The iodine-based etching solution of the present invention is used to etch a material in which a palladium material and a metal material other than the palladium material coexist.

The iodine-based etching solution of the present invention comprises a water-compatible organic solvent and a water-soluble polymer compound. In addition, the iodine-based etching solution of the present invention comprises, similar to general iodine-based etching solutions, water, iodine, and iodide.

Each of the components is described below.

The iodine-based etching solution of the present invention comprises iodine and iodide.

Examples of iodide are not particularly limited, and include potassium iodide, sodium iodide, ammonium iodide, rubidium iodide, cesium iodide, magnesium iodide, calcium iodide, strontium iodide, zinc iodide, cadmium iodide, mercury iodide (II), lead iodide (II), etc., and it is possible to use one or more of these. In particular, as the iodide, from the viewpoints of solubility in water, cost, ease of handling, and toxicity, potassium iodide, sodium iodide, ammonium iodide are preferred.

The content of iodine in the iodine-based etching solution is not particularly limited, and it may be, for example, 1-1000 mM, and preferably 50-500 mM.

The content of iodide in the iodine-based etching solution is not particularly limited, and it may be, for example, 1-3000 mM, and preferably 150-1500 mM.

In addition, the ratio of content of iodine to that of iodide (molar concentration ratio, iodine:iodide) is not particularly limited, and it is preferably 1:3 to 1:10, more preferably 1:5 to 1:10.

The iodine-based etching solution of the present invention comprises a water-soluble polymer compound.

Generally, the water-soluble polymer compound has a heteroatom in its molecule, thereby possessing polarity and water solubility. Meanwhile, due to its polarity, the water-soluble polymer compound is able to adhere to the surface of a metal material upon etching, thereby enabling suppression of the formation of metal iodides and their complexes with an organic solvent; as a result, etching rate of the metal material can be decreased.

Examples of such water-soluble polymer compound are not particularly limited, and those that can decrease the etching rate of the metal material by adhering to the metal material surface may be used; for example, one or more selected from group consisting of natural polymer compounds, synthetic polymer compounds and derivatives thereof may be used alone or in combination thereof.

Natural polymer compounds and derivatives thereof are not particularly limited, and examples include starch, modified starch such as carboxymethyl starch, starch phosphate, or cationic starch, etc.; cellulose derivatives such as methyl cellulose, hydroxyethyl cellulose, hydroxypropyl cellulose, cationic cellulose, carboxymethyl cellulose, etc.; guar gum, xanthan gum, alginic acid, gum arabic, carrageenan, pullulan, sodium chondroitin sulfate, sodium hyaluronate and derivatives thereof, collagen and derivatives thereof, chitosan, as well as gelatin and polypepton, etc.

Synthetic polymer compounds and derivatives thereof are not particularly limited, and examples include polyalkylene glycols such as polyethylene glycol, polypropylene glycol, and etc., poly(alkyl vinyl ether) such as poly(methyl vinyl ether), etc., polystyrene derivatives such as sodium polystyrene sulfonate, etc., polyisoprene derivatives such as sodium polyisoprene sulfonate, etc., naphthalene derivatives such as a salt of naphthalene sulfonic acid condensate etc., polyethyleneimine, polyethyleneimine derivatives such as polyethyleneimine xanthate, etc., polyalkyl(meth)acrylamide such as polyisopropyl(meth)acrylamide, etc., polyvinyl alcohol, polyvinyl pyrrolidinone, poly(meth)acrylamide, poly(meth)acrylic acid and derivatives thereof, polyamidine and copolymers thereof, polyvinyl imidazolinone, dicyandiamide condensate, epichlorohydrin-dimethylamine condensate, and dialkyl diallyl ammonium halide polymers and copolymers such as dimethyl diallyl ammonium chloride polymers and copolymers, etc.

Among those described above, from the viewpoints of solubility in iodine-based etching solution and stability in the solution, it is preferable that, as the water-soluble polymer compound, one or more kinds are selected from the group consisting of polyvinyl alcohol, polyvinyl pyrrolidinone and polyethyleneimine.

Furthermore, the water-soluble polymer compound may be any of nonionic, anionic, cationic or amphoteric polymer compound. Of these, when the water-soluble polymer compound is a nonionic polymer compound, while the water-soluble polymer compound adheres to the metal material, its formation of a coordination compound with a metal constituting the metal material is suppressed; consequently, the etching rate of the metal material in the etching solution can be sufficiently decreased.

Examples of such nonionic water-soluble polymer compound include starch, methyl cellulose, hydroxyethyl cellulose, hydroxypropyl cellulose, guar gum, xanthan gum, polyalkylene glycol, poly(alkyl vinyl ether), polyvinyl alcohol, polyvinyl pyrrolidinone, etc.

In addition, the weight-average molecular weight of the water-soluble polymer compound is not particularly limited, and preferably it is 300 or more, more preferably 300-500000, and furthermore preferably 500-150000. When the weight-average molecular weight of the water-soluble polymer compound is the lower limit value or more, then formation of a coordination compound of the water-soluble polymer compound by its coordination to the metal constituting the metal material is suppressed; as a result, the etching rate of the metal material in the etching solution can be sufficiently decreased. On the other hand, when the weight-average molecular weight of the water-soluble polymer compound is the upper limit value or less, the water-soluble polymer compound becomes more likely to dissolve in the etching solution, and the water-soluble polymer compound can sufficiently exert its effect.

The content of the water-soluble polymer compound in the etching solution is not particularly limited, and it can be appropriately changed depending on the kind and concentration of organic solvent as well as the kind of water-soluble polymer compound; for example, it is preferably 1-1000 ppm, more preferably 10-1000 ppm, and furthermore preferably 50-500 ppm. Within such ranges, the etching strength for a metal material can be suppressed while maintaining the etching strength for a palladium material, so that etching selectivity for palladium material can be increased.

Furthermore, the iodine-based etching solution of the present invention comprises a water-compatible organic solvent.

Examples of such organic solvent are not particularly limited as long as they are water-compatible, and one or more kinds of any organic solvents may be used alone or in combination thereof.

Here, the organic solvent preferably includes one or more kinds selected from the group consisting of nitrogen-containing five-membered ring compound, alcohol compound, amide compound, ketone compound, ether compound, organic sulfur compound, amine compound and imide compound.

Examples of nitrogen-containing five-membered ring compound include pyrrolidinone, imidazolidinone, oxazole, thiazole, oxadiazole, thiadiazole, tetrazole, triazole, etc., or derivatives thereof. Preferred specific examples of nitrogen-containing five-membered ring compound include N-methyl-2-pyrrolidinone (NMP), 2-pyrrolidinone, polyvinyl pyrrolidinone, 1-ethyl-2-pyrrolidinone, 1,3-dimethyl-2-imidazolidinone, 2-imidazolidinone, 2-imino-1-methyl-4-imidazolidinone, 1-methyl-2-imidazolidinone, 2,5-bis(1-phenyl)-1,1,3,4-oxazole, 2,5-bis(1-phenyl)-1,3,4-thiazole, 2,5-bis(1-phenyl)-4,3,4-oxadiazole, 2,5-bis(1-naphthyl)-1,3,4-oxadiazole, 1,4-bis[2-(5-phenyloxadiazolyl)]benzene], 1,4-bis[2-(5-phenyloxadiazolyl)-4-tert-butylbenzene], 2,5-bis(1-naphthyl)-1,3,4-thiadiazole, 1,4-bis[2-(5-phenylthiadiazolyl)]benzene, 2,5-bis(1-naphthyl)-4,3,4-triazole, 1,4-bis[2-(5-phenyltriazolyl)]benzene, etc. Among these, pyrrolidinone derivatives such as NMP, 2-pyrrolidinone, etc., or imidazolidinone derivatives such as 1,3-dimethyl-2-imidazolidinone, etc. are more preferred, and NMP is furthermore preferred.

Examples of alcohol compound include alcohols having a carbon number of 1 to 10, which may be saturated or unsaturated, and in any of the linear, branched or cyclic chain structure, and may be a polyol having 2 or more hydroxyl groups. Preferable specific examples of alcohol compound include linear or branched chain alcohols such as methanol, ethanol, 1-propanol, 2-propanol (IPA), hexanol, etc., diol compounds such as ethylene glycol, propylene glycol, 1,4-butanediol, 1,6-hexanediol, diethylene glycol, dipropylene glycol, other mono-, di-, or tri-alkylene glycol (glycol compound), etc., triol compounds such as 1,2,4-butanetriol, 1,2,3-propanetriol, 1,2,3-hexanetriol, etc., cyclic alcohols such as 1-cyclopentanol, 1-cyclohexanol, etc. Of these, glycol compounds such as diethylene glycol and dipropylene glycol are more preferred.

Amide compounds may be those having an amide group, and may also have a substituent such as nitro group, phenyl group, halogen group, etc. Preferred specific examples of amide compound include N-methylformamide, N,N-dimethylformamide, N,N-diethylformamide, N-methylacetamide, N, N-dimethylacetamide, N-methyl propionamide, acrylamide, adipamide, acetamide, 2-acetamidoacrylic acid, 4-acetamido-benzoic acid, 2-acetamido-benzoic acid methyl, acetamido acetic acid ethyl, 4-acetamidophenol, 2-acetamidofluorene, 6-acetamido-hexanoic acid, p-acetamido benzaldehyde, 3-acetamido diethyl malonate, 4-acetamido-butyric acid, amido sulfuric acid, ammonium amidosulfate, amidol, 3-aminobenzamide, p-amino benzene sulfonamide, anthranilamide, isonicotinamide, N-isopropylacrylamide, N-isopropyl-1-piperazineacetamide, urea amide lyase, 2-ethoxy benzamide, erucyl amido, oleic acid amide, 2-chloroacetamide, glycine amide hydrochloride, succinic acid amide, succinic acid diamide, salicylamide, 2-cyanoacetamide, 2-cyano-thioacetamide, diacetamido, diacetone acrylamide, diisopropyl formamide, N,N-diisopropyl isobutyl amide, N,N-diethyl acetoacetamide, N,N-diethyl acetamide, N,N-diethyl dodecanoic acid amide, N,N-diethyl-nicotinamide, dicyanodiamide, N,N-dibutyl formamide, N,N-dipropyl acetamide, N,N-dimethyl propionamide, N,N-dimethyl benzamide, stearic acid amide, sulfanilamide, sulfabenzamide, sulfamic acid, dansylamide, thioacetamide, thio isonicotinamide, thiobenzamide, 3-nitrobenzamide, 2-nitrobenzamide, 2-nitrobenzene sulfonamide, 3-nitrobenzene sulfonamide, 4-nitrobenzene sulfonamide, pyrroline amide, pyrazinamide, 2-phenyl butyl amide, N-phenylbenzamide, phenoxyacetamide, phthalamide, fumaramide, N-butyl-acetamide, n-butylamide, propionamide, hexanoic acid amide, benzamide, benzenesulfonamide, formamide, malonamide, methanesulfonamide, N-methylbenzamide, N-methyl maleic acid amide, iodoacetamide, etc. Of these, N-methylformamide and N, N-dimethylacetamide, etc. are more preferable.

Examples of ketone compound includes ketone compounds having a carbon number of 3-10, and preferred specific examples of ketone compound include linear ketone compounds such as acetone, methyl ethyl ketone, 4-hydroxy-2-methyl-pentanone, etc., cyclic ketone compounds such as cyclohexanone, etc., cyclic ester compounds such as γ-butyrolactone, etc., carbonate ester compounds such as ethylene carbonate, propylene carbonate, etc. Among these, linear ketone compounds such as acetone, etc., and carbonate ester compounds such as ethylene carbonate, etc. are more preferable.

Examples of ether compound include water-soluble ether compounds, and preferred specific examples of ether compound include tetrahydrofuran, dioxane, ethylene glycol dimethyl ether, etc.

Examples of organic sulfur compounds include dialkyl sulfoxides such as dimethyl sulfoxide, etc., mercapto group-containing compounds such as mercapto succinic acid, etc., and 2,2′-thiodiacetic acid, etc. Of these, dialkyl sulfoxides such as dimethyl sulfoxide, etc. are preferable.

Preferable specific examples of amine compound include urea, glycine, iminodiacetic acid, N-acetyl ethanolamine, N-acetyl-diphenylamine, allylamine, allylamine hydrochloride, allylcyclohexylamine, isoallylamine, isobutylamine, isopropanolamine, isopropylamine, ethanolamine, ethanolamine hydrochloride, ethylamine hydrochloride, N-ethyl ethanolamine, N-ethyl ethylenediamine, N-ethyl diisopropylamine, N-ethyl diethanolamine, N-ethyl dicyclohexylamine, N-ethyl-n-butylamine, 2-ethylhexylamine, N-ethylbenzylamine, N-ethyl methyl amine, ethylenediamine sulfate, ethylenediaminetetraacetic acid, ethylenediaminetetraacetic acid tripotassium trihydrate, ethylenediaminetetraacetic acid trisodiumdihydrate, ethylenediamine, ethoxyamine hydrochloride, diallylamine, diisobutylamine, diisopropanolamine, diisopropylamine, diethanolamine, diethanolamine hydrochloride, diethylamine, diethylamine hydrochloride, diethylenetriamine, dicyclohexylamine, diphenylamine, diphenylamine hydrochloride, dimethylamine hydrochloride, N,N-dimethyl allylamine, succinamic acid, stearylamine, stearylamine hydrochloride, sulfamic acid, thiamine hydrochloride, thiamine sulfate, triisopropanolamine, triisopentylamine, triethylenediamine, trisulfanylamine, tribenzylamine, trimethylene diamine, monoethanolamine, monoethanolamine hydrochloride, etc.

Preferred specific examples of imide compound include linear or cyclic imide compounds such as succinimide, hydroxysuccinimide, N-iodosuccinimide, N-acryloxy succinimide, N-acetyl phthalimide, 3-aminophthalimide, 4-aminophthalimide, N-aminophthalimide, imidurea, N-ethyl phthalimide, N-ethylmaleimide, N-carbethoxy phthalimide, carbodiimide, N-chlorosuccinimide, cyclohexylmide, 2,6-dichloroquinone chloroimide, 3,3-dimethyl glutarimide, 1,8-naphthalimide, 3-nitro phthalimide, 4-nitro phthalimide, N-hydroxy phthalimide, potassium phthalimide, maleic acid imide, N-methylsuccinimide, iodosuccinimide, etc.

Among those described above, in order to be able to maintain stable etching rate of palladium material, those having low volatility are preferred. Examples of such organic solvent include nitrogen-containing five-membered ring compound, glycol compound, diol compound, triol compound, amide compound, etc. In particular, MMP having good wettability during etching is preferred.

Here, “less volatile” means, for example, the vapor pressure of an organic solvent at 25° C. is 5 kPa or less, preferably 2 kPa or less.

The content of the organic solvent in the iodine-based etching solution is not particularly limited; preferably, an amount of use is appropriately adjusted depending on the kind of organic solvent used. In general, it can be used in a range of 1-99 vol %, preferably 10-60 vol %, and more preferably 20-60 vol %. For example, when the additive is MMP, its amount of use is preferably 40-60 vol %, more preferably 50-60 vol %.

Furthermore, the iodine-based etching solution comprises water.

The content of water in the iodine-based etching solution is not particularly limited, and it can be a residual amount of other components. For example, the content of water can be 1-99 vol %, preferably 20-50 vol %.

The iodine-based etching solution of the present invention may comprise a thiocyanate compound and other components, in addition to the above-described components.

When the iodine-based etching solution comprises a thiocyanate compound, the etching rate of palladium material can be furthermore increased, and consequently, the etching selectivity for the palladium material can be improved.

Examples of thiocyanate compound include ammonium salts of thiocyanate, thiocyanate salts with alkaline earth metals such as magnesium and calcium, etc., thiocyanate salts with alkali metals such as sodium and potassium, etc. Of these salts, from the viewpoint of improving the etching rate ratio described above, ammonium thiocyanate or potassium thiocyanate is preferred.

Regarding the concentration of a thiocyanate compound in the iodine-based etching solution, it is preferable that the amount of use is appropriately adjusted depending on the kind of an additive; it is preferably 0.01-2 mol/L, more preferably 0.1-1.5 mol/L, and furthermore preferably 0.2-1 mol/L. In the case of ammonium thiocyanate, its concentration is preferably 0.15-1.0 mol/L, more preferably 0.4-1.0 mol/L, and furthermore preferably 0.4-0.8 mol/L. In the case of potassium thiocyanate, its concentration is preferably 0.3-1.0 mol/L, more preferably 0.4-1.0 mol/L, and furthermore preferably 0.6-0.8 mol/L. When the concentration is in such ranges, it is possible to improve the etching strength for palladium material, while suppressing that for other metal materials. Here, when the organic solvent is NMP, effects of the thiocyanate compound can be exhibited with certainty.

The above-described iodine-based etching solution of the present invention is used for etching a material in which a palladium material and a metal material other than the palladium material coexist.

Examples of the palladium material include palladium, and an alloy of palladium with magnesium, aluminum, titanium, manganese, iron, cobalt, nickel, molybdenum, tungsten, platinum, gold, silver, copper, etc.; the iodine-based etching solution can be applied to one of them or a combination of two or more kinds thereof.

When a palladium alloy is used as the palladium material, in order to increase the above-described etching rate ratio, the content of palladium in the palladium alloy is preferably 60 wt % or more, and more preferably 80 wt % or more.

Examples of metal materials other than palladium material are not particularly limited, and include gold, cobalt, nickel, aluminum, molybdenum, tungsten, etc., as well as alloys thereof; the iodine-based etching solution can be applied to one of them or a combination of two or more kinds thereof.

Among those described above, as the metal material, use of gold or gold alloy is preferred. Then, high etching rate ratio can be obtained more reliably when the iodine-based etching solution is used.

The ratio of etching rate of a palladium material to that of the above metal material (etching rate of palladium material/etching rate of other metal material) is not particularly limited; for example, it is 1.5 or more, preferably 2.0 or more.

Examples of a material in which the above palladium material and a metal material other than the palladium material coexist are not particularly limited, and include, for example, semiconductor materials such as semiconductor substrate, silicon wafer, transparent conductive electrode, etc.

When the iodine-based etching solution of the present invention is applied to such a material, the above high etching rate ratio is obtained; however, needless to say, when it is used for each of the above palladium material and metal materials individually, general etching effects as an etching solution can be obtained.

The iodine-based etching solution of the present invention may be produced by any method. For example, the iodine-based etching solution of the present invention can be prepared by adding components such as the above organic solvent and the water-soluble polymer compound, etc. into a publicly known iodine-based etching solution. Alternatively, it may be prepared by mixing each component in water.

The iodine-based etching solution of the present invention is not necessarily prepared in advance; for example, it may be prepared by the above methods immediately prior to etching.

Next, the etching method of the present invention is described.

The etching method of the present invention is a method of etching a material in which a palladium material and a metal material other than the palladium material coexist using an iodine-based etching solution,

wherein the iodine-based etching solution comprises a water-compatible organic solvent and a water-soluble polymer compound,
wherein the method comprises a step of adjusting the ratio of etching rate of the palladium material to that of the metal material by adjusting the content (s) of the organic solvent and/or water-soluble polymer compound in the iodine-based etching solution (first step).

In this embodiment, following the above step, the method further comprises a step of etching a material in which a palladium material and a metal material other than the palladium material coexist (second step).

In the first step, at first, the ratio of etching rate of the palladium material to that of the metal material is adjusted by adjusting the content(s) of the organic solvent and/or water-soluble polymer compound in the iodine-based etching solution of the present invention.

By increasing the content of the organic solvent or water-soluble polymer compound, the above etching rate ratio increases, and by decreasing said content, the above etching rate ratio decreases. In the etching method of the present invention, etching rate ratio can thus be arbitrarily controlled within a fairly wide range, such as 0.5-3.0.

Here, the contents of the organic solvent and the water-soluble polymer compound can be changed, for example, within the above-mentioned range.

Next, in the second step, a material in which a palladium material and a metal material other than the palladium material coexist is etched.

The etching conditions of this step are not particularly limited, and may be in accordance with conditions of a known etching method, for example.

Regarding the contact method of an object to be etched (material) with the iodine-based etching solution, its examples include dipping method wherein an object to be etched is dipped in the iodine-based etching solution filled in a container. At this time, it is preferable to shake the object to be etched, or to forcibly circulate the iodine-based etching solution in the container. By means of this, the object to be etched is homogeneously etched.

In addition, spraying method wherein the iodine-based etching solution is adhered by spraying onto an object to be etched, and spinning method wherein the iodine-based etching solution is discharged via a nozzle to an object to be etched while the object is spinning, may be used. Furthermore, these methods may be combined with the dipping method.

Etching time is not particularly limited, and may be, for example, 1-60 min.

In addition, etching temperature (for dipping method, the temperature of the iodine-based etching solution; for spraying method and spinning method, the temperature of the iodine-based etching solution or the temperature of the object to be etched) is not particularly limited, and may be 20-50° C. At this time, the temperature of the iodine-based etching solution or the object to be etched, etc. may be controlled by heating means such as a heater, etc., or cooling means, if necessary.

While the present invention has been described above in detail with reference to preferred embodiments, the present invention is not limited thereto, and each configuration can be replaced with any one that is capable of exhibiting similar functions, or any configuration can be added.

### EXAMPLES

Hereinafter, the present invention is explained more specifically using examples; however, the present invention is not limited to these examples.

### Comparative Example 1

A test was performed on the assumption of etching palladium on a wafer in which palladium and gold coexist. 200 mL of an etching solution comprising 567 mM of potassium iodide, 93 mM of iodine, and 60 vol % of N-methyl-2-pyrrolidinone (NMP) were prepared. Then, a palladium specimen and a gold specimen (2×2 cm) were dipped in the above etching solution for etching for 2 min while the solution was weakly stirred at 30° C. The etching rates of palladium and gold were calculated by weight method, and the ratio of etching rates (Pd/Au ratio) was calculated. Table 1 shows the result. As shown in Table 1, the etching rate of palladium decreases when a water-soluble polymer compound is not contained, resulting in a low Pd/Au ratio.

### Example 1

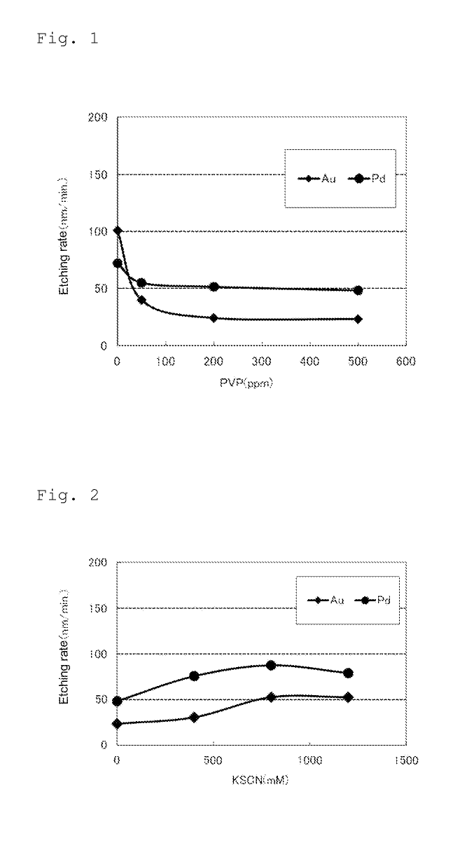

A test was performed on the assumption of etching palladium on a wafer in which palladium and gold coexist. Three kinds of etching solutions (200 mL each) were prepared by blending 50 ppm, 200 ppm or 500 ppm of polyvinylpyrrolidinone (PVP, weight-average molecular weight: 4000) into the above etching solution of Comparative Example. Then, a palladium specimen and a gold specimen (2×2 cm) were dipped in the above etching solution for etching for 2 min while the solution was weakly stirred at 30° C. The etching rates of palladium and gold were calculated by weight method, and Pd/Au ratio was calculated. The results are shown in Table 1 and FIG. 1.

TABLE 1

| | Amount of | Etching rate | Etching rate | |
|---|---|---|---|---|
| | addition of | of Pd | of Au | Etching rate |
| | PVP (ppm) | (nm/min) | (nm/min) | ratio (Pd/Au) |
| Com. Ex. 1 | 0 | 72 | 101 | 0.7 |
| Ex. 1 | 50 | 55 | 40 | 1.4 |
| | 200 | 52 | 24 | 2.1 |
| | 500 | 48 | 23 | 2.1 |

The results presented in Table 1 and FIG. 1 show that, by comprising polyvinylpyrrolidinone as a water-soluble polymer compound, the etching rate of palladium becomes higher than that of gold, and as a result, Pd/Au ratio increases.

### Example 2

A test was performed on the assumption of etching palladium on a wafer in which palladium and gold coexist. An etching solution comprising 567 mM of potassium iodide, 93 mM of iodine, and 60 vol % of NMP and 500 ppm of PVP, as well as three kinds of etching solutions in which 400 mM, 800 mM. or 1200 mM. of potassium thiocyanate was blended into the above etching solution were prepared (total of 4 kinds, 200 mL each). Then, a palladium specimen and a gold specimen (2×2 cm) were dipped in the above etching solution for etching for 2 min while the solution was weakly stirred at 30° C. The etching rates of palladium and gold were calculated by weight method, and Pd/Au ratio was calculated. The results are shown in Table 2 and FIG. 2.

TABLE 2

| | Amount of addition | Etching rate | Etching rate | |
|---|---|---|---|---|
| | of KSCN | of Pd | of Au | Etching rate |
| | (mM) | (nm/min) | (nm/min) | ratio (Pd/Au) |
| Ex. 2 | 0 | 48 | 23 | 2.1 |
| | 400 | 76 | 30 | 2.5 |
| | 800 | 87 | 53 | 1.7 |
| | 1200 | 79 | 53 | 1.5 |

The results presented in Table 2 and FIG. 2 show that, by comprising a thiocyanate compound, the increasing effect of etching rate of palladium becomes stronger than the increasing effect of etching rate of gold, and as a result, Pd/Au ratio further increases.

### Example 3

Instead of using NMP in Example 2 (amount of addition of KSCN: 800 mM), compounds listed in Table 3 (organic solvents) were used with the contents shown in Table 3, and etching was performed similarly to Example 2. Table 3 shows the results.

TABLE 3

| | | | Etching | Etching | Etching |
|---|---|---|---|---|---|
| | | | rate of | rate of | rate |
| | | Content | Pd | Au | ratio |
| | Organic solvent | (vol %) | (nm/min) | (nm/min) | (Pd/Au) |
| Ex. 2 | N-methyl-2- | 60 | 87 | 53 | 1.7 |
| (KSCN: | pyrrolidinone | | | | |
| 800 mM) | | | | | |
| Ex. 3 | 2-pyrrolidinone | 20 | 229 | 156 | 1.5 |
| | 2-propanol | 40 | 203 | 139 | 1.5 |
| | | 60 | 225 | 152 | 1.5 |
| | Propylene glycol | 40 | 166 | 110 | 1.5 |
| | Diethylene glycol | 40 | 150 | 101 | 1.5 |
| | Dipropylene | 20 | 209 | 117 | 1.8 |
| | glycol | | | | |
| | Dimethyl | 60 | 86 | 59 | 1.5 |
| | acetoamide | | | | |
| | γ-butyrolactone | 40 | 245 | 162 | 1.5 |
| | | 60 | 160 | 83 | 1.9 |
| | Acetone | 60 | 144 | 98 | 1.5 |
| | Dimethyl | 20 | 273 | 173 | 1.6 |
| | sulfoxide | 40 | 215 | 141 | 1.5 |
| | | 60 | 131 | 87 | 1.5 |

As shown in Table 3, Pd/Au ratios were improved by the use of any of the organic solvents, compared to the case without any water soluble polymer compound and thiocyanate compound (Comparative Example 1). Specifically, under the conditions listed in Table 3, all the Pd/Au ratios were 1.5 or more. In addition, it was demonstrated that the Pd/Au ratio can be adjusted by adjusting the concentration of the organic solvent.

### Example 4

A test was performed on the assumption of etching palladium on a wafer in which palladium and gold coexist. Two kinds of etching solutions (200 mL each) were prepared by blending 50 ppm or 200 ppm of polyvinyl alcohol (weight-average molecular weight: 500) into the above etching solution of Comparative Example 1. Then, a palladium specimen and a gold specimen (2×2 cm) were dipped in the above etching solution for etching for 2 min while the solution was weakly stirred at 30° C. The etching rates of palladium and gold were calculated by weight method, and Pd/Au ratio was calculated. Table 4 shows the results obtained, together with the results of Comparative Example 1.

TABLE 4

| | Amount of addition | | Etching | |
|---|---|---|---|---|
| | of polyvinyl | Etching | rate | |
| | alcohol | rate of Pd | of Au | Etching rate |
| | (ppm) | (nm/min) | (nm/min) | ratio (Pd/Au) |
| Com. Ex. 1 | 0 | 72 | 101 | 0.7 |
| Ex. 4 | 50 | 91 | 99 | 0.9 |
| | 200 | 92 | 80 | 1.1 |

The results presented in Table 4 show that, by comprising polyvinyl alcohol as a water-soluble polymer compound, the etching rate of palladium becomes higher than that of gold, and as a result, Pd/Au ratio increases.

### Comparative Example 2

A test was performed on the assumption of etching palladium on a wafer in which palladium and gold coexist. 200 mL of an etching solution comprising 567 mM of potassium iodide, 93 mM of iodine, 20 vol % of dipropylene glycol, and 800 mM of potassium thiocyanate were prepared. Then, a palladium specimen and a gold specimen (2×2 cm) were dipped in the above etching solution for etching for 2 min while the solution was weakly stirred at 30° C. The etching rates of palladium and gold were calculated by weight method, and the ratio of etching rates (Pd/Au ratio) was calculated. Table 5 shows the result.

### Example 5

A test was performed on the assumption of etching palladium on a wafer in which palladium and gold coexist. Two kinds of etching solutions (200 mL each) were prepared by blending 50 ppm or 500 ppm of polyethyleneimine (weight-average molecular weight: 2000) into the above etching solution of Comparative Example 2. Then, a palladium specimen and a gold specimen (2×2 cm) were dipped in the above etching solution for etching for 2 min while the solution was weakly stirred at 30° C. The etching rates of palladium and gold were calculated by weight method, and Pd/Au ratio was calculated. Table 5 shows the results.

TABLE 5

| | Amount of addition | | | Etching |
|---|---|---|---|---|
| | of | Etching rate | Etching rate | rate |
| | polyethyleneimine | of Pd | of Au | ratio |
| | (ppm) | (nm/min) | (nm/min) | (Pd/Au) |
| Com. Ex. 2 | 0 | 222 | 209 | 1.1 |
| Ex. 5 | 50 | 241 | 179 | 1.4 |
| | 500 | 187 | 118 | 1.6 |

The results presented in Table 5 show that, by comprising polyethyleneimine as a water-soluble polymer compound, the etching rate of palladium becomes higher than that of gold, and as a result, Pd/Au ratio increases.

1. An iodine-based etching solution to etch a material in which a palladium material and a metal material other than the palladium material coexist, comprising a water-compatible organic solvent and a water-soluble polymer compound.

2. The iodine-based etching solution according to claim 1, wherein the water-soluble polymer compound decreases the etching rate of the metal material by adhering to the surface of the metal material.

3. The iodine-based etching solution according to claim 1, wherein the water-soluble polymer compound is one or more kinds selected from the group consisting of polyvinyl alcohol, polyvinyl pyrrolidinone, and polyethylene imine.

4. The iodine-based etching solution according to claim 1, wherein the water-soluble polymer compound is a nonionic polymer compound.

5. The iodine-based etching solution according to claim 1, wherein the weight-average molecular weight of the water-soluble polymer compound is 300 or more.

6. The iodine-based etching solution according to claim 1, wherein the content of the water-soluble polymer compound is 1-1000 ppm.

7. The iodine-based etching solution according to claim 1, wherein the organic solvent comprises one or more kinds selected from the group consisting of a nitrogen-containing five-membered ring compound, an alcohol compound, an amide compound, a ketone compound, an organic sulfur compound, an amine compound, and an imide compound.

8. The iodine-based etching solution according to any one of claim 1, wherein the concentration of the organic solvent is 1-60 vol %.

9. The iodine-based etching solution according to claim 1, further comprising a thiocyanate compound.

10. The iodine-based etching solution according to claim 1, wherein the metal material is one or more kinds selected from the group consisting of gold, cobalt, nickel, aluminum, molybdenum, tungsten, and an alloy thereof.

11. The iodine-based etching solution according to claim 1, wherein the metal material is gold or gold alloy.

12. A method of etching a material in which a palladium material and a metal material other than the palladium material coexist using an iodine-based etching solution according to claim 1.

13. A method of etching a material in which a palladium material and a metal material other than the palladium material coexist using an iodine-based etching solution,
wherein the iodine-based etching solution comprises a water-compatible organic solvent and a water-soluble polymer compound,
wherein the method comprises a step of adjusting the ratio of etching rate of the palladium material to that of the metal material by adjusting the content (s) of the organic solvent and/or the water-soluble polymer compound in the iodine-based etching solution.
